(19) United States
(12) Patent Application Publication
(10) Pub. No.: US 2012/0030082 A1
(43) Pub. Date: Feb. 2, 2012

(54) PREDICTIVE MODELING FOR DEBT PROTECTION/CANCELLATION

(75) Inventors: Allan S. Voltz, Browns Summit, NC (US); Mark R. Hoffmann, Los Angeles, CA (US)

(73) Assignee: BANK OF AMERICA CORPORATION, Charlotte, NC (US)

(21) Appl. No.: 12/847,884

(22) Filed: Jul. 30, 2010

(51) Int. Cl. G06Q 40/00

(52) U.S. Cl. 705/35

(57) ABSTRACT

A method for predictive modeling is disclosed. Economic data associated with at least one economic trend is received. Claim and cancellation data associated with a financial product of a financial institution is generated, where the claim and cancellation data is based on past data. The economic data is used with the claim and cancellation data to forecast model future claim and cancellation data of a plurality of loans.

### BACKGROUND

Financial institutions issue loans and other financial products to customers. Some of these loans or financial products may likely result in a loss for the financial institution due to defaults or cancellation of loans, especially during recessionary times or times when the economy fluctuates. There is no current way to accurately predict or forecast the claims or cancellations of a debt cancellation product or what potential loans or financial products will result in a loss for a financial institution.

### SUMMARY

Embodiments of the invention can provide a solution to the above-described problem and/or other problems by providing methods, apparatuses, and computer program products for predictive modeling by forecasting claims and/or cancellations of a financial product. This, in turn, will allow the financial institution to streamline forecast the losses for the financial institution based on the product. Additionally, the financial institution allows for more effective pricing of products as well as better development of products.

According to some embodiments of the invention, a method for predictive modeling includes receiving economic data associated with at least one economic trend, generating claim and cancellation data associated with a financial product of a financial institution and forecast modeling, using a computer, the economic data with the claim and cancellation data to predict future claim and cancellation data of a plurality of loans.

In accordance with some other embodiments, an apparatus includes memory configured to receive economic data. The apparatus also includes a processor configured to generate claim and cancellation data associated with a financial product of a financial institution, and forecast model the claim and cancellation data and the economic data to predict future claim and cancellation data of a plurality of loans.

In accordance with some other embodiments, a computer program product for process monitoring is disclosed. The computer program product includes a non-transitory computer readable medium, wherein the non-transitory computer readable medium includes computer-executable program code stored therein. The computer-executable program code is configured to perform a method, where the method includes receiving economic data associated with at least one economic trend, generating claim and cancellation data associated with a financial product of a financial institution and forecast modeling, using a computer, the economic data with the claim and cancellation data to predict future claim and cancellation data of a plurality of loans.

Other aspects and features of the present invention, as defined by the claims, will become apparent to those skilled in the art upon review of the following non-limited detailed description of the invention in conjunction with the accompanying figures.

### BRIEF DESCRIPTION OF DRAWINGS

Having thus described embodiments of the invention in general terms, reference will now be made the accompanying drawings, wherein:

FIG. 1 is a high-level overview of a method for a predictive modeling in accordance with an embodiment of the present invention.

FIG. 2 is a flow chart of a method for a predictive modeling in accordance with another embodiment of the present invention.

FIGS. 3A-3I (collectively “FIG. 3”) is another flow chart of a method for a predictive modeling in accordance with another embodiment of the present invention.

FIG. 4A is an illustration of data used in the predictive modeling in accordance with an embodiment of the present invention.

FIG. 4B is an example of predictive modeling data in accordance with an embodiment of the present invention.

FIG. 4C is another example of predictive modeling data in accordance with an embodiment of the present invention.

FIG. 5 is an illustration of data used in the predictive modeling in accordance with an embodiment of the present invention.

FIG. 6 is a block schematic diagram of an example of predictive modeling in accordance with an embodiment of the present invention.

### DETAILED DESCRIPTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Like numbers refer to like elements throughout.

It should be understood that terms like “lending institution,” “borrower,” “servicer,” “investor,” “financial institution,” and even just “institution” or “entity” are used herein in their broadest sense. Institutions, organizations, or even individuals that process loans are widely varied in their organization and structure. Terms like lending institution, financial institution and even “entity” are intended to encompass all such possibilities, including but not limited to, banks, finance companies, brokerages, credit unions, mortgage companies, insurance companies, entities who grant loans to secure the purchase of property, any combinations thereof, a third party entity separate from any of the above, and/or the like. Additionally, disclosed embodiments may suggest or illustrate the use of agencies or contractors external to the institution to perform some of the method steps disclosed herein. These illustrations are examples only, and an institution or business can implement the entire invention on their own computer systems or even a single work station if appropriate databases are present and can be accessed.

It should be noted that embodiments of the present invention may be applied to various products, such as a “borrower's protection plan (“BPP”),” which is discussed in U.S. patent application Ser. No. 10/710,206, filed Jun. 25, 2004 and U.S. patent application Ser. No. 12/350,225, filed Jan. 7, 2009, the entire disclosure of both are incorporated herein by reference. Under BPP, assertion of a claim relates to an occurrence of covered event triggering a payout to the borrower and therefore, resulting in a loss to the financial institution of the BPP product. Additionally, under BPP, cancellation relates to canceling of the BPP product for various reasons, such as default on the loan.

Other products that embodiments of the present invention are applicable to relates to “credit protection plus” (“CP+”) and “credit protection deluxe” (“CPD”). Both of the products provide consumer protection on a credit card in the event that a triggering event has happened. The consumer protection can include waiving a fee, providing a credit to the consumer, waiving/cancelling interest payments or principal payments owed by the consumer, and the like. The triggering events can include any triggering events discussed in U.S. patent application Ser. No. 10/710,206, such as disability of the borrower, involuntary unemployment, loss of life, hospitalization, and other events which could affect the ability of the borrower to make regular payments on a loan or on a credit card bill.

It should be understood that the present invention is not limited to the above-described applications of BPP, CP+ or CPD and the present invention may be used in a variety of other manners consistent with the scope of the invention as discussed herein. Particularly, some embodiments of the present invention can be used with any product where a financial institution may occur a loss due to events such as cancellation or claims on a product.

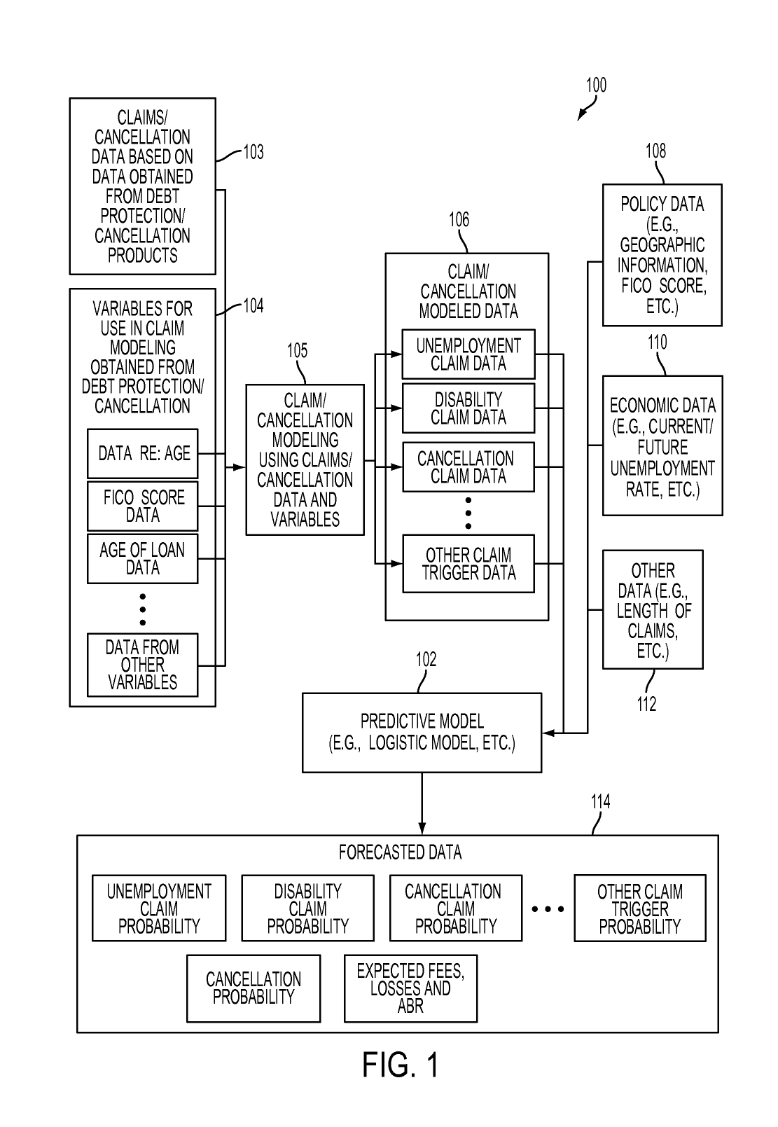

FIG. 1 is a high-level overview of a method 100 for a predictive modeling in accordance with an embodiment of the present invention. As previously discussed, debt protection/cancellation products assist consumers from going into default on a loan or a credit card. The debt protection/cancellation products generate various data, such as claims and cancellation data 103, for the plurality of customers that use the debt protection/cancellation product(s). The claims and cancellation data 103 refers to data about a borrower asserting a claim for the debt protection/cancellation product because a triggering event has occurred and the protection/cancellation portion of the debt protection/cancellation product becomes active. For example, if a borrower has BPP and a triggering event occurs (e.g., involuntary unemployment), BPP will now activate to protect the borrower, such as by covering the loan payments while the borrower is unemployed. By way of another example, if a customer has CP+ and owns a credit card and becomes disabled (which is a covered triggering event), CP+will then activate to assist the customer during the disability so that the customer does not default on the credit card, such as by issuing a $500 credit or cancelling at least a portion of the credit card payment that is due.

Further, the claims and cancellation data 103 also refers to data regarding customers cancelling a loan or credit card at the financial institution. If the customer no longer wants the loan or credit card, the loan or credit card can be cancelled. However, the financial institution may like to know this information so that the financial institution can take the cancellation data into consideration for future products, better customer service, customer retention, and the like.

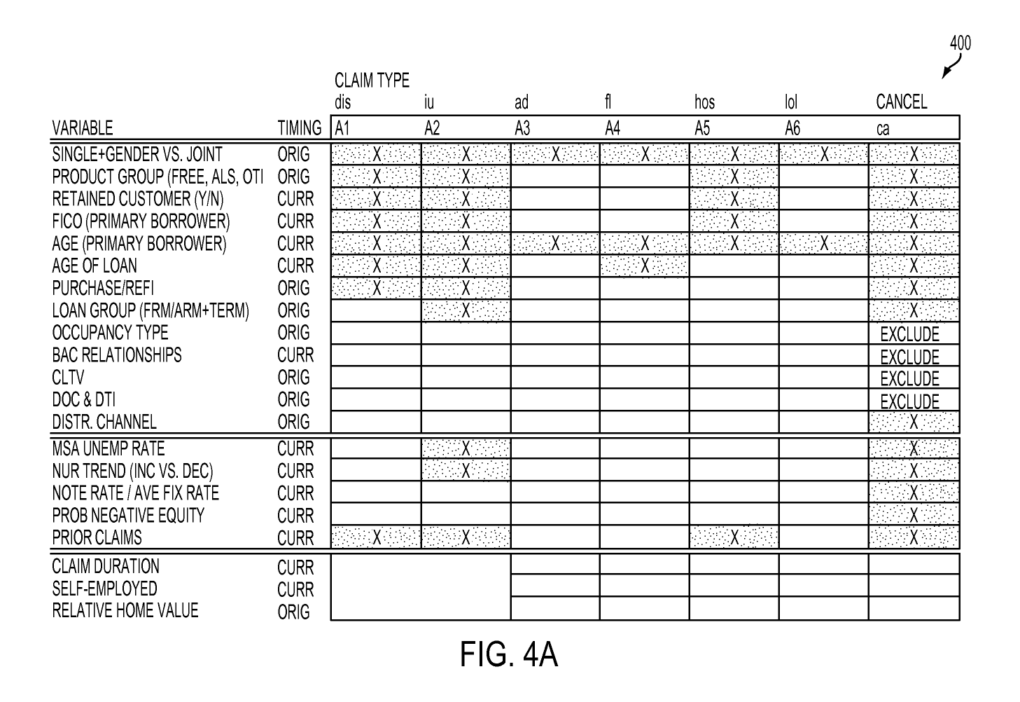

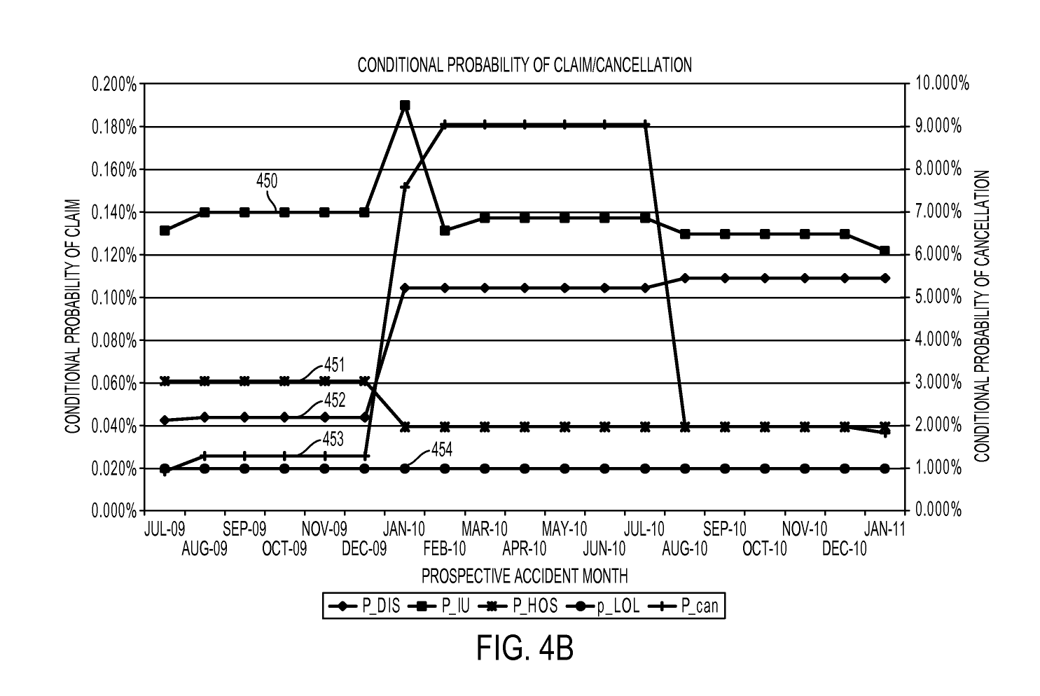

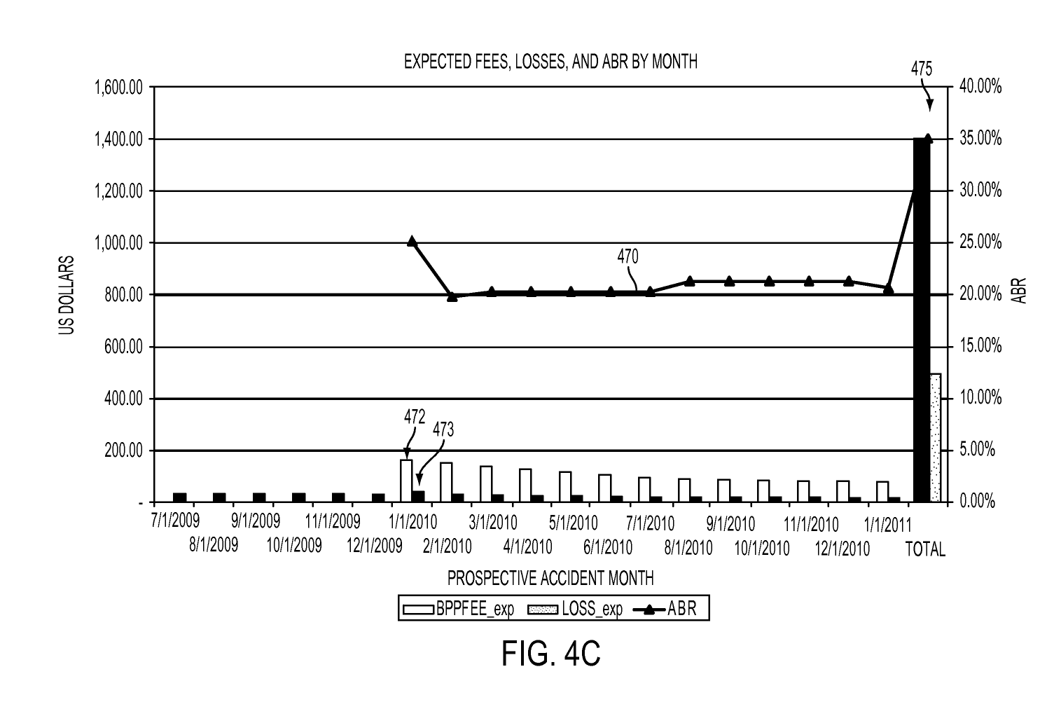

Additionally, the plurality of customers (e.g., primary borrower) have various information associated with the debt protection/cancellation products, including, but not limited to, customer age, borrower's gender, FICO score of the customer, age of the loan/credit card, product type, combined loan-to-value ratio, whether the customer is retained, purchase/refinancing information, loan group information, customer relationship with the financial institution, distribution channel, geographic location of the borrower, and any other information that may be relevant to whether a customer asserts a claim or cancels a debt protection/cancellation product of the financial institution. This information is illustrated as block 104 of FIG. 1 and an example of the variables are shown in FIG. 4A, which is later described. It should be understood that, while the present invention shows a limited number of variables for use in the claim/cancellation modeling, there can be any number of variables and the present invention should not be limited to the few exemplary variables disclosed herein.

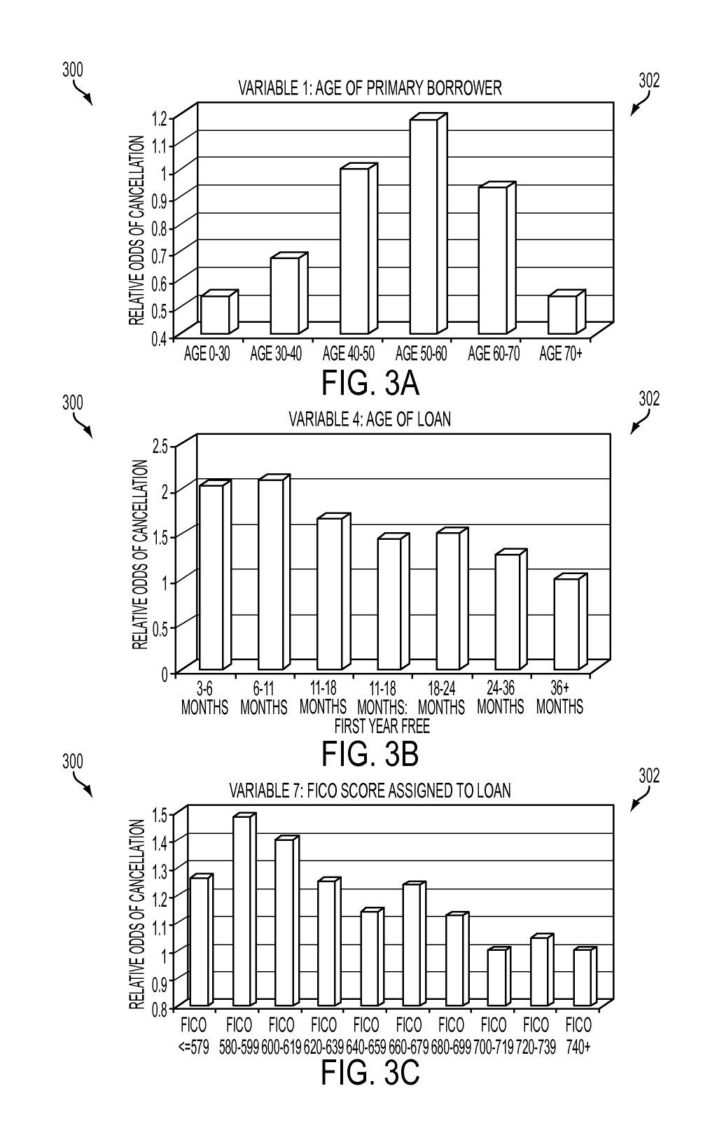

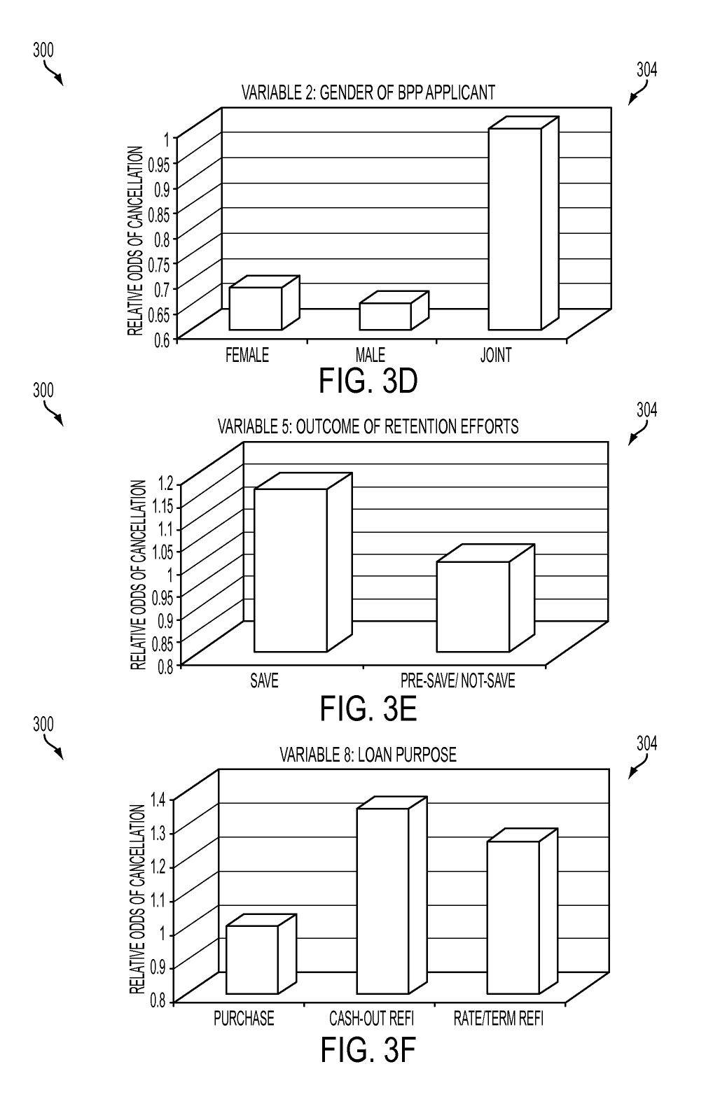

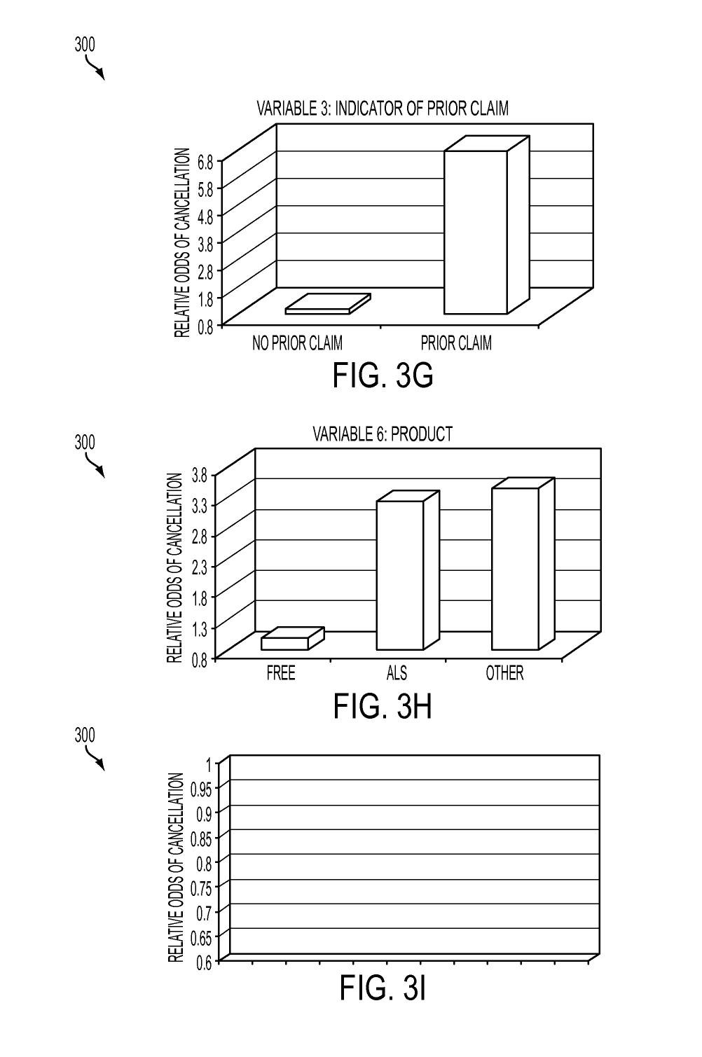

As illustrated in block 105 of FIG. 1, the claims cancellation data 103 and the data from the claim/cancellation variables 104 are input into the claim/cancellation model 105. The claim/cancellation model 105 then performs data analysis to quantify relationships between the claims and cancellation data and the variables 104. This relationship is referred to in FIG. 1 as “claim/cancellation modeled data” 106. Examples of the claim/cancellation model data 106 are illustrated in FIGS. 3A-3I (collectively “FIG. 3”), as is discussed later. The claim/cancellation model data 106 can include models based on claim triggering events of unemployment, disability, cancellation, and any other claim trigger data. This data shows the relationships between the claim triggering events and the claim/cancellation variables 103.

After the claim/cancellation data has modeled historical claim/cancellation data using the historical data obtained from debt protection/cancellation products, a predictive model 102 is employed that receives various inputs, including the claim/cancellation model data 106, policy data 108 and economic data 110. Other data 112 may also be received by the predictive model 102. As previously discussed, the claim and cancellation model data 106 includes the historical data indicating various relationships between customer variables and claim and cancellations of a loan by the customer. Policy data 108 includes data such as geographical information, customer FICO scores, gender, customer age, property location, and other information about the customer and the customer's loan owned by the financial institution where the customer has the loan (or credit product). Policy data 108 can also include loan characteristics such as balance, utilization percentage, purchase APR, standalone, outbound telemarketing channel, income, minimum payment, whether the borrower is current on payments, when the loan originated, and the like. Economic data 110 includes data about the current or future state of the economy, such as the current or predicted unemployment rate, (e.g., national unemployment rate (NUR) trends, etc.). The economic data 110 also includes various data based on geographic locations, such as the unemployment data specific to specific geographic areas (e.g., cities, states, geographic regions, etc.) including the metropolitan specific area (“MSA”) unemployment rate. All of the data 106-112 (and optionally, the historical claim/cancellation data 103 and 105) is received by the predictive model 102, which in turn provides forecasted data 114 about the debt protection/cancellation product, as will be discussed in more depth below. It should be noted that the predictive model may be comprised of a multitude of models and does not need to be necessarily one predictive model.

The forecasted data 114 that results gives claim probabilities for each claim type, such as unemployment claim probability, disability claim probability, and claim probabilities for other possible claims for the debt protection/cancellation products. The forecasted data 114 also includes an overall probability of claims as an aggregate for all debt protection/cancellation products. The forecasted data 114 further includes the probability of cancellation (FIG. 4B) for each and/or all of debt protection/cancellation products so that the financial institution can determine which debt protection/cancellation product(s) will perform the best based on the customer data variables 104, policy data 108, economic data 110 and any other data 112. The forecasted data 114 may further include expected fees and losses (FIG. 4C) of the financial institution for the debt protection/cancellation products based on the forecasted claims and cancellations for the debt protection/cancellation products. This allows for financial institutions to more accurately predict losses and fees in times of recessions.

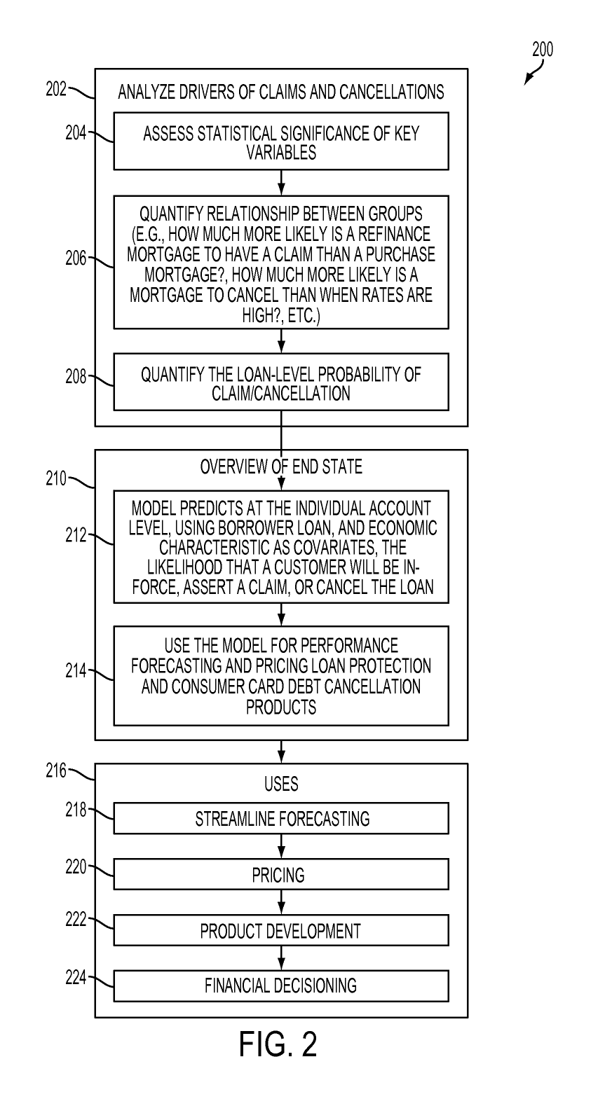

FIG. 2 is a flow chart of a method for a predictive modeling in accordance with an embodiment of the present invention. In block 202, drivers of claims and cancellations are analyzed. Block 202 substantially relates to blocks 103-106 of FIG. 1. Sub-blocks 204-208 further define this process. In block 204, the statistical significance of key variables 104 is assessed and groups of data are formed. Various weights may be placed on the key variables 104, as desired, to more accurately predict expected claims and cancellations. In block 206, the relationship between various data groups is quantified through the use of modeling. For example, it is determined how much more likely is a refinance mortgage to have a claim than a purchase mortgage, how much more likely is a mortgage to cancel than when rates are high, etc. These relationships are based on claim/cancellation data 103 and key variable data 104 that is already owned and managed by the financial institution. Examples of such data are shown in FIGS. 3A-3I (collectively “FIG. 3”).

As illustrated in FIGS. 3A-3I (collectively “FIG. 3”), various variables are presented in bar graphs 300, which present a relationship between the particular variable and the odds of cancellation of the loan. The relative odds of cancellation in FIG. 3, as stated in the graphs, should be taken as meaning the relative odds of a disability (disability is only an example and any other claim type can also be modeled). As shown in the upper left-hand corner 302 of FIG. 3A, “variable 1:Age of Primary Borrower” presents a correlation between the age of the borrower and the odds of cancellation of the debt protection/cancellation product. For example, a person who is 45 years old is about 20% less likely to have the loan cancelled than a person who is 55 years old and almost double the odds of having a loan cancelled than a person who is older than 70 years old. Regarding “variable 2: Gender of BPP Applicant,” the gender of the borrower is shown relative to the odds of cancellation where a male or female is much less likely to cancel the loan as compared with joint ownership of the loan. Other variables indicating the odds of cancellation are also illustrated, such as the an applicant having a prior claim, the age of the loan, outcome retention efforts, product group, FICO score assigned to the loan, and the loan purpose. This list is by no means exhaustive and various other variables are also used in obtaining historical and relationship data for use in the model 104. The variables used in FIG. 3 are determined based on a table of variables which indicates which variables of the key variables 104 affect the odds of cancellation. The table of variables is illustrated in FIG. 4A.

In FIG. 4A, an illustration 400 of the relationship between the key variables 104 and the claim types are shown. This table 400 provides to the model which variables 104 to use in the model and what claims are likely given a specific variable and claim type. For example, the age of the borrower has a correlation with the disability claim (“dis”), involuntary unemployment (“iu”), accidental death (“ad”), family leave (“fl”), and cancellation (“cancel”), as shown in the table of FIG. 4A. Viewing the claim type of disability (which is shown in FIG. 3), it is shown that the key variables that are used in the model are: gender of the primary borrower (“Single+Gender vs. Joint”), product group, outcome retention efforts (“Retained customer (y/n)”), FICO score assigned to the loan, age of the primary borrower, prior claim, the age of the loan, and the loan purpose (“Purchase/Refi”). Certain variables may not be conclusive, and thus, these variables would be excluded from the calculations. For example, as shown in the table of FIG. 4A, occupancy type, current customer relationships, combined loan-to-value ratio (“CLTV”), and debt-to-income and doc loans (“DOC & DTI”) each were excluded due to not having enough data to draw a conclusion. It should be noted that economic variables are also included in the table, such as the unemployment rate and the note rate/average fixed rate.

Nonetheless, after a user input which claim type(s) the user wishes to model, the model accesses the table 400 of FIG. 4A to determine which variables will be modeled. After determining the variables to model, the predictive model 104 then retrieves the data associated with the select variables and runs the retrieved data with claim cancellation data through the claim model to quantify the relationship between the variables and the odds of cancellation for the selected claim type(s). This process is illustrated in block 208 of FIG. 2, where the loan-level probability of a claim or cancellation is performed.

In block 210, an overview of the end state is performed, including sub-blocks 212 and 214. In block 212, a forecasting model uses the loan-level probability of claims and cancellation as well as economic characteristics and borrower loan information as covariates, to predict the likelihood that a customer will be “inforce” (i.e., the loan is current), a claim will be asserted or that the loan will be cancelled. This is performed at the individual account level. This loan-level information is then used in the forecasting model for performance forecasting and pricing loan protection and consumer card debt cancellation products as shown in block 214.

The forecasting model uses a logistic regression separately data for each claim type and cancellation. Within each moth, the “bad” loan is defined as the claim type/cancellation being modeled within that regression; the “good loan is defined as surveying to the next age. Logistic regression is equivalent to a generalized linear model with binary response variable and logout link function. A unit change in the value of the explanatory variable should change the odds p/(1−p) by a constant multiplicative amount. The logistic regression used in the exemplary embodiment is:

$$z = log ( \frac{p}{1 - p} ) = {\sum }_{i = 0}^{n} {β}_{i} {X}_{i} \\ p = \frac{{e}^{z}}{1 + {e}^{z}}$$

An example of probabilities of the claims or cancellation is illustrated in FIG. 4B and an example of expected fees and losses are illustrated in FIG. 4C. FIG. 4B illustrates curves indicating the conditional probability of an involuntary unemployment claim 450, conditional probability of hospitalization claim 451, conditional probability of disability 452, and conditional probability of loss of life 454 (as viewed against the lefthand Y-axis). FIG. 4B also illustrates the conditional probability of cancellation 453 (as viewed against the righthand Y-axis). As illustrated at January 2010, a fee increase drives up monthly cancellation probability from 1% to 9% per month and the monthly disability probability 452 increases from 0.04% to 0.1%. The involuntary unemployment claim 450 would also increase if not for the fact that the trend in the unemployment rate start to decline in February 2010, mooting the impact of increasing fees for the loan. An increasing in fee actually drives down hospitalization claim probability 451.

Turning the FIG. 4C, an example of the expected fees 472, expected losses 473 and ABR 470 (i.e., the losses/fees) by month as well as a total aggregated amount shown on the righthand portion 475 of the graph. The expected fees 472 and expected losses 473 are viewed against the lefthand Y-axis and the ABR 470 is viewed against the righthand Y-axis. As illustrated, the financial institution expects to collect $1391 in fees in 2010, expects to pay out $486 in claims in 2010 and expects a resulting ABR of 35% (which is calculated by dividing $486 by $1391).

The forecasted data relates to the potential losses that would be incurred by the particular product being forecasted based on, not only historical data and loan data, but also based on current and projected economic data, such as the projected unemployment rate, projected interest rates, or other data which may have any effect on a claim or cancellation. As shown in block 216, the uses could include streamline forecasting 218 of cancellation/claims and losses of products, pricing of products 220, product development 222, financial decisioning 224, etc. Because this forecasting model performs calculations that are relevant using certain data streams, forecasting is streamlined as a single product. Additionally, due to the fact that loan losses will be able to be accurately predicted, the pricing of the product can be performed with more accuracy. For example, if the financial institution sees that there will likely be high losses on a product, the product would need to be priced higher to accommodate these higher losses or for the risk of these higher losses. Next, product development can take advantage of the forecasting model. If product developers understand what causes the claims or cancellations, the product may be adjusted at that variable level so to somehow reduce the level of probability of a claim or cancellation. It should be understood that other uses also exist and that the present invention should not be limited to the list of uses discussed.

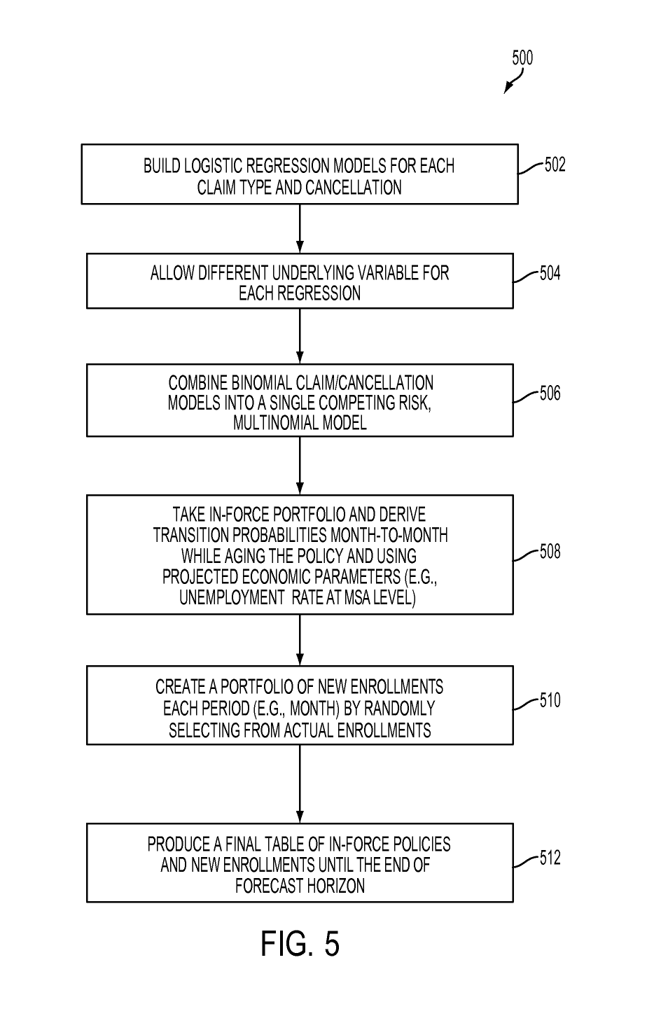

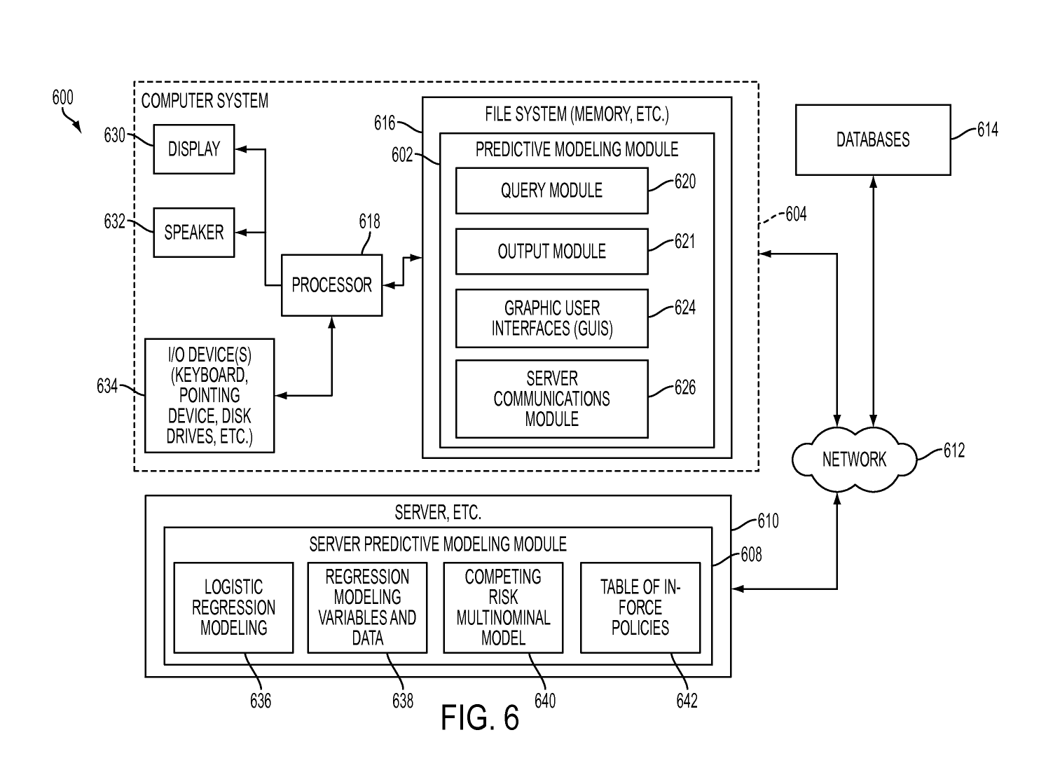

FIG. 5 is a flow chart for a predictive modeling using the model approach in accordance with another embodiment of the present invention. In block 502, a logistic regression models are built for each claim type and cancellation. In block 504, different underlying variables are associated with each regression. In block 506, a single competing risk multinomial model is formed from binomial claim/cancellation models. In block 508, inforce portfolios are used and transition probabilities are derived month to month while aging the policy and using projected economic parameters (e.g., NUR/MSA unemployment rates, etc.). A portfolio of new enrollments is then created for each period by randomly selecting from actual enrollments, as shown in block 510. In block 512, a final table is then produced of inforce policies and new enrollments until the end of the forecast horizon.

FIG. 6 is a block schematic diagram of an example of predictive modeling in accordance with an embodiment of the present invention. The system 600 includes a predictive modeling module 602 operable on a computer system 604, or similar device of a user or client. Alternatively, or in addition to the predictive modeling module 602 on the user's computer system 604 or client, the system 600 includes a server predictive modeling module 608 operable on a server 610 and accessible by the user 606 or client 604 via a network 612. The methods 100-200 and 500 are embodied in or performed by the predictive modeling module 602 and/or the server predictive modeling module 610. For example, in one embodiment, the methods 100-200 and 500 are performed by the predictive modeling module 602. In another embodiment of the invention, the methods 100-200 and 500 are performed by the server predictive modeling module 608. In a further embodiment of the present invention, some of the features or functions of the methods 100-200 and 500 are performed by the predictive modeling module 602 on the user's computer system and other features or functions of the methods 100-200 and 500 are performed on the server predictive modeling module 608.

Databases 614 are operable on and/or communicative with the server 610. The databases 614 include databases housing historical data, economic data, policy data or other data as described above with regard to FIG. 1. It should be understood that the databases 614 may be databases other than those owned by a bank, such as FICO databases, economic indicator databases, geographical information databases, and any other financial information databases. The network 612 is the Internet, a private network, wireless network, or other network.

The predictive modeling module 602 and/or 608 is a self contained system with embedded logic, decision making, state based operations and other functions that operates in communication with the databases 614.

The predictive modeling module 602 is stored on a file system 616 or memory of the computer system 614. The predictive modeling module 602 is accessed from the file system 616 and run on a processor 618 associated with the computer system 614.

The predictive modeling module 602 includes a query module 620. The query module 620 allows a financial institution representative or other user to input various data and/or queries into the computer system 604, such as requests for forecast information, parameters of a query, information that may be input into the predictive model and the like. The query module 620 is accessed or activated whenever the financial institution representative or other user desires to input information, obtain queries and/or call other modules such as GUIs 624 as described below.

The predictive modeling module 602 also includes an output module 621. The output module 621 outputs results of any query and modeling performed on the server 610. The output module 621 communicates with the server communication model 626 so as to retrieve information to output on the display 630.

The predictive modeling module 602 further includes a server communications module 626. The server communications module 626 transmits any information from the user's computer 604 to the server 610, such as the queries from the query module 620, and receives information from the server 610. The server communications module 626 communicates the data to be transmitted or received with other modules on the computer 604, such as with the query module 620, the output module 621, etc.

The user computer system 604 includes a display 630 and a speaker 632 or speaker system. The display presents the any information on the screen to the user. Any GUIs 624 associated with the predictive modeling is also presented on the display 630. The speaker 632 presents any voice or other auditory signals or information to the user.

The user computer system 604 also includes one or more input devices, output devices or combination input and output device, collectively I/O devices 634. The I/O devices 634 include a keyboard, computer pointing device or similar means to enter information into various GUIs 624 as described herein. The I/O devices 634 also include disk drives or devices for reading computer media including non-transitory computer-readable medium or computer-operable instructions.

The predictive modeling module 608 presents one or more predetermined GUIs 624 to permit the establishment, input and management of the predictive modeling system 600 and methods 100-200 and 500. These GUIs 624 may be predetermined and presented in response to the user indicating the user would like to enter or receive information and/or settings. The GUIs 624 are generated by the predictive modeling module 602 and/or the server predictive modeling module 608 and are presented on the display 630 of the computer system 604. The GUIs 624 also include GUIs to permit the financial institution representative to manage the predictive modeling actions and results.

The server predictive modeling module 608 includes logistic regression modeling 636, regression modeling variables and data 638, competing risk multinomial model 640, and table of inforce policies 642. These modules 636-642 allow for modeling of the data obtained from databases 614 or other sources as previously discussed with regard to methods 100-200 and 500 of FIGS. 1-2 and 5, respectively. For example, the logistic regression modeling 636 includes the models that are used to determine relationships between modeling variables and data 638 and also models used for forecasting of claims/cancellations as well as forecasting losses of the financial institution. It should be understood that the modules operable on the server may all be operated on a single computer and need not be a server separate from computer 604 and/or separate from databases 614.

The terminology used herein is for the purpose of describing particular embodiments only and is not intended to be limiting of the invention, unless the context clearly indicates otherwise. As used herein, the singular forms “a”, “an” and “the” are intended to include the plural forms as well, unless the context clearly indicates otherwise. It will be further understood that the terms “comprises,” “includes,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function. In one embodiment, a processor is a microprocessor that includes electrical hardware components.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method of predictive modeling comprising:
receiving economic data associated with at least one economic trend;
generating claim and cancellation data associated with a financial product of a financial institution, wherein the claim and cancellation data is based on past data; and
forecast modeling, using a computer, the economic data with the claim and cancellation data to predict future claim and cancellation data of a plurality of loans.

2. The method of claim 1, wherein the economic data varies based on the geographic area of borrowers for each on the plurality of loans.

3. The method of claim 1, further comprising receiving policy data of the plurality of loans, wherein the forecast modeling is further based on the policy data.

4. The method of claim 1, wherein the generating claim and cancellation data comprises modeling the claim and cancellation data using a loan-level model to generate data indicating a relationship between variables and a rate of cancellation or claims on the plurality of loans.

5. The method of claim 1, wherein the economic data comprises involuntary unemployment data.

6. The method of claim 1, further comprising forecasting losses of a financial institution based on the future claim and cancellation data.

7. The method of claim 1, wherein the financial product comprises a loan offered at the financial institution that allows for a claim to be asserted by the borrower in the event of a covered event occurring and allows for cancellation of the loan in the event of default.

8. The method of claim 7, wherein the claim and cancellation data comprises data associated with at least one of a borrower asserting a claim and the loan being cancelled.

9. The method of claim 1, wherein the claim and cancellation data comprises data associated with at least one of a borrower on the loan asserting a claim due to a covered event occurring and the loan being cancelled, either of which results in a loss for the financial institution.

10. The method of claim 1, wherein the financial product comprises a borrower's protection product where a portion of a loan for the borrower is covered on behalf of the borrower in response to a covered event occurring.

11. A method of predictive modeling comprising:
generating claim and cancellation data associated with a financial product of a financial institution; and
forecast modeling, by a computer, the claim and cancellation data to predict future claim and cancellation data of a plurality of loans.

12. The method of claim 11, further comprising receiving economic data associated with economic trends, wherein the economic data varies based on the geographic area of borrowers for each on the plurality of loans.

13. The method of claim 11, further comprising receiving policy data of the plurality of loans, wherein the forecast modeling is further based on the policy data.

14. The method of claim 11, wherein the financial product comprises a loan offered at the financial institution that allows for a claim to be asserted by the borrower in the event of a covered event occurring.

15. The method of claim 14, wherein the covered event comprises one of income curtailment, disability of the borrower, involuntary loss of employment, hospitalization and accidental death.

16. The method of claim 11, further comprising modeling the claim and cancellation data using a loan-level model to generate data indicating a relationship between variables and a rate of cancellation or claims on the plurality of loans.

17. The method of claim 11, further comprising forecasting losses of a financial institution based on the future claim and cancellation data.

18. An apparatus for predictive modeling comprising:
memory configured to receive economic data; and
a processor configured to:
generate claim and cancellation data associated with a financial product of a financial institution; and
forecast model the claim and cancellation data and the economic data to predict future claim and cancellation data of a plurality of loans.

19. The apparatus of claim 18, wherein the economic data varies based on the geographic area of borrowers for each on the plurality of loans.

20. The apparatus of claim 18, wherein the processor is further configured to model the claim and cancellation data using a loan-level model to generate data indicating a relationship between variables and a rate of cancellation or claims on the plurality of loans

21. The apparatus of claim 18, wherein the processor is further configured forecast losses of a financial institution based on the future claim and cancellation data.

22. The apparatus of claim 18, wherein the processor is further configured receive policy data of the plurality of loans, wherein the forecast modeling is further based on the policy data.

23. A computer program product comprising non-transitory computer readable medium, wherein the non-transitory computer readable medium comprises computer-executable program code stored therein, the computer-executable program code configured to perform a method of predictive modeling, the method comprising:
receiving economic data associated with economic trends;
generating claim and cancellation data associated with a financial product of a financial institution, wherein the claim and cancellation data being based on historical data; and
forecast modeling, using a computer, the economic data with the claim and cancellation data to predict future claim and cancellation data of a plurality of loans.

24. The computer program product of claim 23, wherein the method further comprises receive policy data of the plurality of loans, wherein the forecast modeling is further based on the policy data.

25. The apparatus of claim 23, wherein the method further comprises modeling the claim and cancellation data using a loan-level model to generate data indicating a relationship between variables and a rate of cancellation or claims on the plurality of loans.

26. The apparatus of claim 23, wherein the method further comprises forecasting losses of a financial institution based on the future claim and cancellation data.
